(19) United States
(12) Patent Application Publication
(10) Pub. No.: US 2003/0083963 A1
(43) Pub. Date: May 1, 2003

(54) Automated system for and method of inventory management control

(76) Inventor: Thomas D. Benson, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/004,296

(22) Filed: Oct. 31, 2001

(51) Int. Cl. G06F 17/60

(52) U.S. Cl. 705/28; 705/29

(57) ABSTRACT

The present invention is directed to a system for and a method of electronic inventory management. An electronic inventory management tool preferably comprises a memory for storing an electronic determination of a desired quantity of at least two types of materials, and materials ordering logic configured to supply an electronic message to a supplier of one of the types of material specifying quantity and time frame requirements therefore as a function of the desired quantity, and further configured to process a confirmation message from the supplier. The electronic inventory management tool may further comprise feedback logic coupled to the memory and programmed to provide information with respect to consumption of one of the types of materials to ensure the desired quantity of the one type of material is available.

### TECHNICAL FIELD

The present invention relates to inventory management and more specifically to a system and method for inventory management control.

### BACKGROUND

An important aspect of manufacturing process control includes material inventory control to ensure an adequate on-hand supply of materials required to manufacture a product. Quantities of materials necessary are estimated and purchasing agents are tasked with ensuring these materials are on hand when needed. While the materials are typically ordered with sufficient lead time to ensure their timely arrival, delays in suppliers' schedules or deliveries are normally not discovered until due dates have passed.

When materials are not available when needed, alternate supplies of required materials are sought in an attempt to keep the production line running. During these times, the urgency of locating and obtaining the necessary components are heightened. Production delays, caused by unavailability of necessary materials, increase overall manufacturing costs and reduce the efficiency of the production lines.

### SUMMARY OF THE INVENTION

The present invention is directed to a system for and a method of electronic inventory management. An electronic inventory management tool preferably comprises a memory for storing an electronic determination of a desired quantity of at least two types of materials, and materials ordering logic configured to supply an electronic message to a supplier of one of the types of material specifying quantity and time frame requirements therefore as a function of the desired quantity, and further configured to process a confirmation message from the supplier. The electronic inventory management tool may further comprise feedback logic coupled to the memory and programmed to provide information with respect to consumption of one of the types of materials to ensure the desired quantity of the one type of material is available.

A preferred embodiment of the present invention also includes a method of inventory control comprising electronically determining a required quantity of a material, communicating the quantity and a time frame to a supplier of the material, receiving a confirmation message from the supplier, and using feedback to maintain the quantity of the material on hand.

### BRIEF DESCRIPTION OF THE DRAWINGS

FIG. 1 is a flow chart that shows an embodiment of a method according to the present invention; and

FIG. 2 is a block diagram of an exemplary system that may be used to implement the present invention.

### DETAILED DESCRIPTION

The teachings of the present invention are directed to systems for and methods of cooperating with suppliers to ensure adequate resources are available in production environments. According to a preferred embodiment of the invention, forecasts (e.g., quantities of materials, desired inventory levels, etc.), bills of materials (e.g., materials necessary for production), and material lead time are combined, preferably electronically, to determine the quantity of materials that should be ordered. Materials may be ordered by supplying an electronic message to preselected vendors who preferably confirm their commitment to supplying the quantity of materials necessary at the required time. These messages may be repeated, such as at some regular interval, to confirm the order and delivery schedule has not changed and/or that no delivery problems are expected. Alternatively, if vendors cannot supply the quantity of materials in the desired time frame, and this determination is made early in the planning process, contingencies are preferably developed in that alternate suppliers, alternate materials, and/or alternate sources for the material are investigated.

According to one embodiment of the invention, resource levels are monitored as consumed, and together with the actual run rate and yield of the product, are considered when determining future material orders. Additionally, the inventory levels, forecasts, yield and run rates are preferably re-evaluated and the material orders adjusted to ensure materials are on hand when needed and that excessive materials are not stockpiled.

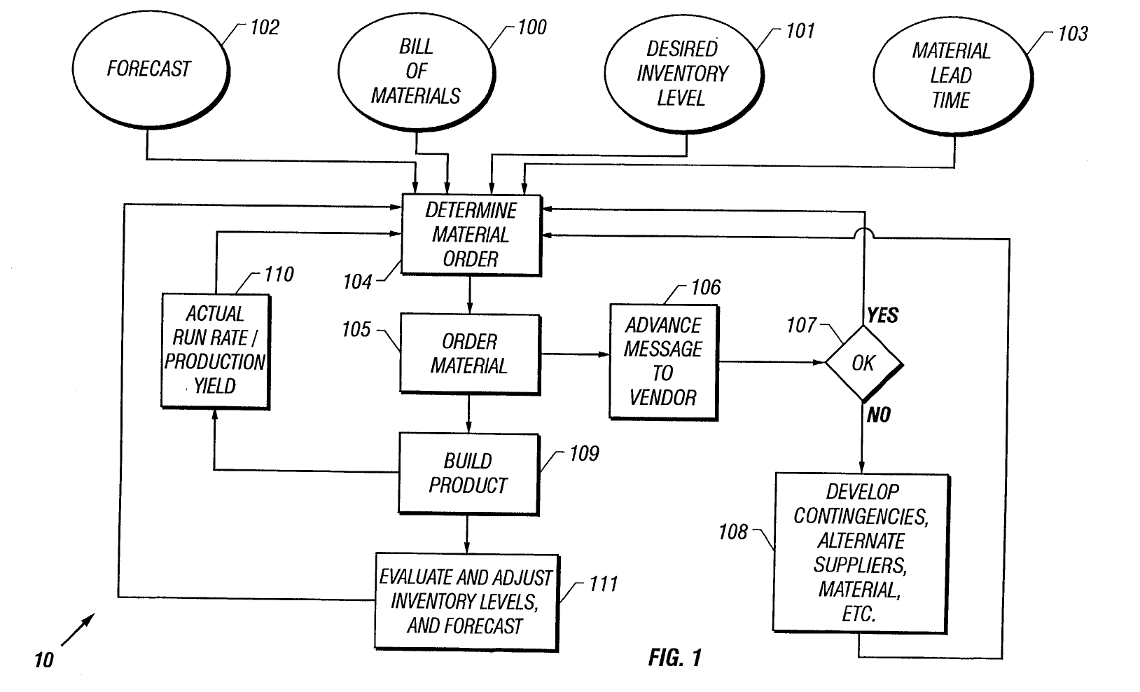

FIG. 1 shows flow chart 10 that depicts a method according to one embodiment of the present invention. Typically when a product is being produced, bill of materials 100 is generated that includes each resource necessary for production of a product. The manufacturer also may specify a desired inventory level 101 that contains the amount of raw material, components and/or assemblies needed to build the product. Desired inventory level 101 may also include information with respect to the number of completed products the manufacturer desires to have on hand or present in inventory, at any time. Additionally, the manufacturer preferably creates forecasts 102 that is an indication of the number of units of the product the manufacturer believes will be sold over some period of time. According to the illustrated embodiment, lead time for ordering and obtaining material from various manufacturers is also identified and provided as an input parameter (material lead time 103). Such lead times may vary between components and/or vendors, thereby affecting order timing.

Bill of materials 100, desired inventory level 101, forecast 102 and material lead time 103, are combined according to the illustrated embodiment at step 104 to determine a material order. It should be appreciated that information in addition to or in the alternative to that shown, e.g., bill of materials forecast, lead time, and desired inventory level, maybe used according to the present invention in determining a material order and/or various aspects thereof. For example, anticipated run rate information may be utilized in determining amount of materials to be ordered an/or delivery schedules for ordered materials. Once the material order is generated, the material is preferably ordered in step 105. Material is preferably ordered by sending electronic messages, such as via an e-mail or even a proprietary message interface, that contain identification of the materials required and delivery time frame to the vendor at step 106.

After order placement, step 106 may be used to transmit order confirmation messages, such as periodically or upon the occurrence of particular events, to vendors requesting that they confirm delivery schedules and/or report any anticipated problems in fulfilling previously accepted and/or updated orders. Requesting periodic confirmation of previously placed and accepted orders reduces the possibilities of “surprises,” such as those associated with vendors being reluctant to communicate likely or impending problems until corrective action by the manufacture is made difficult and alternative sourcing may no longer be a viable option. However, given the availability of information as provided according to the present invention, various materials may be ordered from separate vendors, or the same material may be ordered from several vendors (i.e., multi-sourced) to ensure adequate supplies of the material are on hand when needed.

If the vendor can supply the required material in the time frame desired, and/or confirms that they are “on track” to fulfill a previously accepted order, the vendor preferably confirms the order with that manufacturer. This confirmation may be communicated to the manufacturer in a number of manners. Preferably, an electronic message is sent from the vendor to the manufacturer confirming the material order, acknowledging the associated time frame, and/or giving an indication as to when the delivery of the material will take place (step 107).

Alternatively, if the vendor cannot supply the material desired in the time frame required, step 108 may be used to develop contingencies, identify alternate suppliers, identify alternate material that may be used to substitute for the unavailable material, or to identify other work-around solutions. For example, the vendor may send an electronic message to the manufacturer declining the material order in whole or in part or otherwise altering a material term thereof (step 107). However, the database may store alternate suppliers for various materials and these alternate suppliers may be contacted once the primary supplier has indicated their inability to produce the material required in the time frame desired or has failed to confirm a delivery schedule.

It should be appreciated that the illustrated method proceeds upon multiple paths from step 105 to thereby both order materials for use in the future as well as to continue to utilize on hand materials to build product. As the manufacturer begins/continues building the product in step 109, both the actual run rate and production yield are preferably determined in step 110 and compared to an anticipated run rate and yield (not shown), e.g., that used in determining material orders and/or delivery times in step 104. If the actual run rate determined in step 110 is greater than the anticipated run rate or the yield is less than predicted, additional material orders may be placed to ensure adequate supplies of the required resources are available when needed. Alternatively if the actual run rate in step 110 is determined to be less than the anticipated run rate or yield rates are better than predicted, deliveries corresponding to present orders for additional resources may be delayed or otherwise modified to ensure that adequate, but not excessive, resources are available to the manufacturer at any time (it being appreciated that storage costs and spillage of excessive materials on hand increase the production costs associated with products).

In step 111, the desired inventory levels, forecasts, and/or other factors that may affect the amount of materials on hand, such as actual sales, are preferably re-evaluated to determine if sufficient resources are available. Information regarding re-evaluation of these aspects is preferably fed back to the material order determining step for use in subsequent order determinations and/or order changes or confirmations.

The comparison between actual run rate and anticipated run rate, actual and expected product yield and the evaluation and possible adjustment of inventory levels and forecasts is preferably used to provide feedback for use in the determination of the material order in step 104. For example, after an initial determination of material order in step 104, information from forecasts 102, bills of materials 100, desired inventory level 101, material lead time 103, actual run rate and yield 110, may be “tweaked,” e.g., statistically analyzed and/or reevaluated, at step 111 and combined to determine follow-on material orders or changes to previously placed material orders. Even in the absence of changed parameters, processing may proceed to message generation step 106 to proactively confirm that vendor delivery schedules have not changed, the impact of any such changes, and initiate corrective action, as necessary, at step 108.

When implemented in software, the elements of the present invention are essentially the code segments to perform the necessary tasks. The program or code segments can be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, etc., while transmission media may include, for example, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, an intranet, etc.

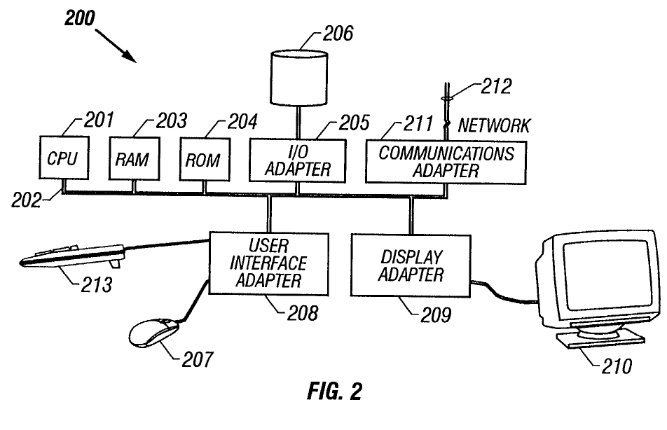

FIG. 2 illustrates computer system 200 adapted to use the present invention. Central Processing Unit (CPU) 201 is coupled to system bus 202. The CPU 201 may be any general purpose CPU, such as an HP PA-8500 or Intel Pentium processor. However, the present invention is not restricted by the architecture of CPU 201 as long as CPU 201 supports the inventive operations as described herein. System bus 202 is coupled to Random Access Memory (RAM) 203, that may be SRAM, DRAM or SDRAM. ROM 204 is also coupled to system bus 202, that may be PROM, EPROM, or EEPROM. RAM 203 and ROM 204 hold user and system data and programs as is well-known in the art.

System bus 202 is also coupled to input/output (I/O) controller card 205, communications adapter card 211, user interface card 208, and display card 209. The I/O card 205 connects to storage devices 206, such as one or more of a hard drive, a CD drive, a floppy disk drive, or a tape drive of the computer system. Communications card 211 is adapted to couple the computer system 200 to a network 212, that may be one or more of a telephone network, a Local (LAN) and/or a Wide-Area (WAN) network, an Ethernet network, and/or the Internet network and can be wire line or wireless. User interface card 208 couples user input devices, such as keyboard 213 and pointing device 207, to computer system 200. Display card 209 is driven by CPU 201 to control display device 210.

What is claimed is:

1. An electronic inventory management tool comprising:
a memory storing an electronic determination of a desired quantity of at least two types of materials;
materials ordering logic configured to supply an electronic message to a supplier of one of said types of material specifying quantity and time frame requirements therefor as a function of said desired quantity, and further configured to process a confirmation message from said supplier; and
feedback logic coupled to said memory and programmed to provide information with respect to consumption of said one of said types of materials to ensure said desired quantity of said one of said types of material is available.

2. The tool of claim 1 wherein said electronic determination includes forecast, bill of materials, an inventory level and material lead time parameters.

3. The tool of claim 1 wherein said materials ordering logic is further configured to periodically supply a confirmation request message to said supplier requesting an updated confirmation of said confirmation message.

4. The tool of claim 1 wherein said feedback logic compares an actual run rate to a corresponding anticipated run rate and an actual production yield to an anticipated production yield.

5. The tool of claim 2 further comprising a feedback mechanism that compares said forecast with actual sales to ensure said desired level of said material is adjusted.

6. The tool of claim 1 further comprising a listing of alternate suppliers for ensuring said desired quantity of said material is available.

7. The tool of claim 6 further comprising a second electronic message sent to said alternate supplier of one of said type of material.

8. A method of inventory control, said method comprising the steps of:
determining, electronically, a required quantity of a material;
communicating said quantity and a time frame to a supplier of said material;
receiving a confirmation message from said supplier; and
using feedback to maintain a desired quantity of said material on hand, wherein said feedback is utilized in re-determining said required quantity of a material.

9. The method of claim 8 further comprising the step of:
supplementing said communication of said quantity and time frame to said supplier as a function of said feedback.

10. The method of claim 8 wherein said step of determining includes processing one of a product forecast, a bill of materials, a material lead time and a desired inventory level.

11. The method of claim 8 wherein said step of communicating is performed via an Internet.

12. The method of claim 8 further comprising a step of transmitting a reminder message to said supplier requesting confirmation of an order corresponding to said confirmation message received from said supplier.

13. The method of claim 8 wherein said step of receiving is performed via an Internet.

14. The method of claim 8 wherein said step of using feedback compares an actual run rate to a corresponding anticipated run rate and an actual production yield to an anticipated production yield.

15. A method of production comprising:
generating a bill of materials for a product;
determining a desired inventory level for said product;
estimating a demand for said product;
determining a material lead time;
combining said bill of materials, said desired inventory level, said material lead time and said demand for said product to determine required timing and quantities of materials;
placing orders via a communications network that includes an Internet for said required quantities of materials with suppliers of said materials; and
using software components to adjust said required quantities of materials based on variations in said forecast and said desired inventory levels.

16. The method of claim 15 wherein said step of placing orders is performed via electronic mail.

17. The method of claim 15 further comprising:
receiving messages from said suppliers wherein said messages are in response to said orders.

18. The method of claim 17 wherein said messages are confirmations of said orders.

19. The method of claim 15 wherein said messages are denials of said orders.

20. The method of claim 17 further comprising:
contacting alternate suppliers via electronic mail wherein said contacting includes placing orders for materials.
